(19) United States
(12) Patent Application Publication
(10) Pub. No.: US 2023/0381831 A1
(43) Pub. Date: Nov. 30, 2023

(54) IMMERSION SYSTEMS & METHODS FOR WASHING & PERFORMING OTHER TASKS

(71) Applicant: IMMERSION SYSTEMS, INC., Topeka, KS (US)

(72) Inventors: JOHN CANTRELL, Prairie Village, KS (US); MARK CHURCHILL, Grain Valley, MO (US); ROGER SHEALY, Fayetteville, GA (US); RICHARD POWERS, Overland Park, KS (US)

(21) Appl. No.: 18/030,805

(22) PCT Filed: Oct. 7, 2021
(86) PCT No.: PCT/US2021/054069

§ 371 Date: Apr. 7, 2023

(51) Int. Cl. B08B 3/08; B08B 3/04; B08B 3/10; B08B 7/04; B08B 7/00

(52) U.S. Cl. CPC B08B 3/08; B08B 3/045; B08B 3/10; B08B 7/04; B08B 7/0064; B08B 2203/007

(57) ABSTRACT

Systems and methods for washing and thawing objects, such as vegetables and fruits, where large amounts of lifting of heavy items is minimized, complex and expensive pumping and manifold systems and structures are not required; and system cost and daily maintenance is reduced. The system includes a structure for holding a volume of fluid, a vertical motion structure driven by an electric motor or the like that raises and lowers a carrier between an elevated position and a lowered position. Programmed control processes address a variety of products, objects, actions, and functions.

### BACKGROUND OF THE INVENTION

### 1. Field of the Invention

The present invention relates generally to systems and methods for washing and thawing objects and masses of objects. The present invention relates more specifically to immersion systems and methods for washing various items and performing other tasks where the process of immersing the items in a body of fluids would have benefit.

### 2. Description of the Related Art

Systems currently available to clean items with fluids use complex pumping systems and manifolds to carry the fluids. These systems jet fluid into tanks where items are washed or treated in other ways. When food products are being washed or thawed all of the pump and manifold parts in such systems must be accessible for frequent cleaning (at minimum daily). This can take considerable time and effort as it typically requires the disassembly of such pumps and manifolds and the scrubbing out and disinfecting of such parts. This drives up the cost to acquire and implement such systems and increases the installation costs. In addition sanitation code compliance issues can and do arise.

Current systems also require operators to lift heavy loads of objects both up and out of the systems. This causes additional strain on an operator. Other systems use very expensive and complex machinery for hydraulically lifting and tilting the entire chamber for holding the items where items are then dumped into hoppers. This process can damage and bruise items and lifting is still required in order to remove the items from the hoppers. On these systems the containers or chambers for holding the items are normally fixed and therefore difficult to customize for specific targeted applications.

### SUMMARY OF THE INVENTION

There exists a need for a system that can wash and thaw objects such as vegetables, fruits, sauces, soups and meat proteins where large amounts of lifting of heavy items is minimized, complex and expensive pumping and manifold systems and structures are not required, and system cost, daily maintenance is reduced, and sanitation code compliance is increased. It is contemplated that if such a system is developed it may have other beneficial applications where immersing other items into a body of fluids would have benefits.

### BRIEF DESCRIPTION OF THE DRAWINGS

FIG. 1 is a perspective view of a self-contained embodiment of the present invention with product baskets raised and immersion chamber cover in place.

FIG. 2 is a perspective view of the self-contained embodiment of the present invention shown in FIG. 1 with product baskets raised and immersion chamber cover removed for product basket access.

FIG. 3 is a perspective view of the self-contained embodiment of the present invention shown in FIG. 1 with product baskets raised, the immersion chamber cover in place, and the valve and chemical systems access drawer open.

FIG. 4 is a partial cutaway perspective view of the self-contained embodiment of the present invention shown in FIG. 1 with product baskets raised, the immersion chamber cover removed, and the front of the immersion chamber removed for clarity.

FIG. 5A is a partial cutaway perspective view of the immersion chamber portion of the self-contained embodiment of the present invention shown in FIG. 1 with product baskets raised to the level of the wash fluid and the front of the wash chamber removed for clarity.

FIG. 5B is a partial cutaway perspective view of the immersion chamber portion of the self-contained embodiment of the present invention shown in FIG. 1 with product baskets lowered into to the wash fluid and the front of the immersion chamber removed for clarity.

FIG. 6 is a perspective view of the interior of the lift system portion of the self-contained embodiment of the present invention shown in FIG. 1 with the front of the lift system cabinet removed for clarity.

FIG. 7 is a detailed perspective view of the upper immersion chamber portion of the self-contained embodiment of the present invention shown in FIG. 1 with product baskets lowered out of view for clarity.

FIGS. 8A-8C are detailed perspective views of the water inlet, fluid flow and chemical systems of the self-contained embodiment of the present invention shown generally in FIG. 1 with some connecting water and chemical flow lines removed for clarity.

FIGS. 9A-9B are perspective views of an alternate embodiment of the present invention structured to hold and wash skewers and the like.

FIG. 9C is a partial cutaway view of the alternate embodiment of the present invention shown in FIG. 9A with the skewer rack positioned above the brushes and the water level, and extended from the system for loading the skewers.

FIGS. 9D-9E are detailed perspective views of the skewer racks of the alternate embodiment of the present invention shown in FIG. 9A showing the process of loading the skewers into the skewer rack.

FIG. 9F is a detailed perspective view of the alternate embodiment of the present invention shown in FIG. 9A showing the process of loading and securing the skewers into the skewer rack.

FIGS. 9G-9L are front and side cutaway views of the alternate embodiment of the present invention shown in FIG. 9A showing the sequential process of lowering the skewers (loaded into the skewer rack) through the brushes and into the fluid filled tank.

FIG. 10 is a schematic block diagram of the water inlet, fluid flow and chemical systems of the present invention, generally tracking the structures shown in FIGS. 8A-8C.

FIG. 11A is a flowchart diagram of the top level operational control method steps associated with generalized operation of the system of the present invention.

FIG. 11B is a flowchart diagram of the typical specific process control method steps associated with operating the system of the present invention to carry out a specific functionality (object washing, thawing, de-glazing, etc.).

FIG. 11C is a flowchart diagram of the typical system maintenance and safety control method steps associated with operating the system of the present invention to monitor its condition and to carry out maintenance and safety functionality.

FIG. 11D is a flowchart diagram of the typical motion parameters and cycles associated with generalized operation of the system of the present invention to carry out a specific functionality (object washing, thawing, de-glazing, etc.).

### DETAILED DESCRIPTION OF THE PREFERRED EMBODIMENTS

The present invention involves washing systems and methods that do not require complex pumping devices or manifolds, can be used as a self-contained system or with existing tanks for holding fluids (such as sinks), greatly minimizes lifting and daily maintenance and cleaning, and can be substantially less expensive to acquire and install. If each of the above objectives of the new and novel designs could be achieved virtually all of the shortfalls of the prior art would be overcome.

The fundamental elements of the present invention are implemented in self-contained systems (with the wash tank incorporated into the system) and in systems that utilizes existing fluid reservoirs and tanks as are commonly found in commercial kitchens. In each embodiment of the systems of the present invention, it is the automated and repeated action of immersing and withdrawing “product” from a fluid bath that achieves the desired results in the most efficient manner. Operating in this manner, the systems and methods of the present invention solve most, if not all, of the problems associated with the prior art.

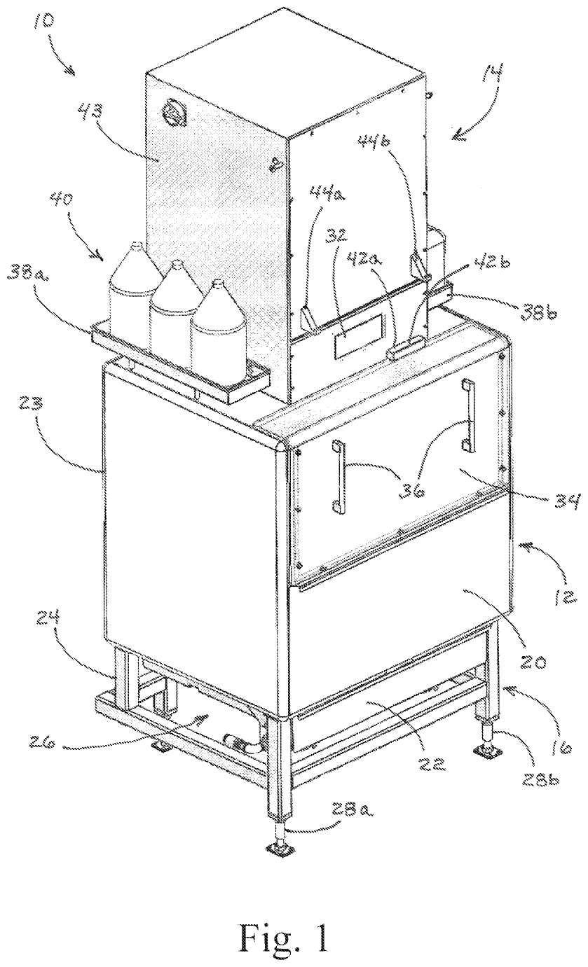

Reference is made first to FIG. 1 which is a perspective view of a self-contained embodiment of the present invention with product baskets raised and immersion chamber cover in place. This stand-alone immersion system 10 is generally constructed of three vertically stacked sub-systems. The base of the immersion system 10 positions water inlet, fluid flow & chemical systems 16 which primarily houses flow lines and valves typically with low voltage sensors and valve actuators. Above water inlet, fluid flow & chemical systems 16 is immersion chamber 12 which provides the physical volume to both hold the fluid into which product is immersed and support the porous containers (baskets) to receive and contain the product being handled. Above immersion chamber 12 is lift system 14 which houses the mechanics of the lifting and immersing system as well as the electrical power components and the electronic control components. This stacked arrangement of the three primary sub-systems not only optimizes access by the user but also puts all high voltage electrical components, and most all sensitive electronic components, above the wet environment of the immersion chamber 12 for purposes of safety and reliability.

Within immersion chamber 12 sub-system are positioned product basket, separator & lid assemblies 18a & 18b which are supported above fluid tank 20 within immersion chamber cabinet 23. In use, fluid tank 20 is filled with water or a water/chemical solution according to the function the system depending on what process it is operating in with the particular product held in product basket, separator & lid assemblies 18a & 18b. Fluid tank 20 is preferably filled automatically through an array of flowlines and control valves, again operated according to the specific functionality required. Additional details regarding the various functional actions the overall immersion system 10 takes during operation with specific products are provided below.

As indicated above, the flow of fluids into fluid tank 20 is generally accomplished by the flowlines & valves 26 positioned within water inlet, fluid flow & chemical systems 16. This sub-system that forms the base of the overall immersion system 10 is supported on base frame 24 which includes an array of leveling legs 28a-28d (28a & 28b visible in FIG. 1). Most control components in water inlet, fluid flow & chemical systems 16 are made accessible by being positioned in valve & chemical systems access drawer 22 which, in FIG. 1, is shown retracted fully into base frame 24. Additional flowlines and connectors are positioned within water inlet, fluid flow & chemical systems 16 below valve & chemical systems access drawer 22 and serve to connect the overall immersion system 10 to incoming water lines (not shown in FIG. 1) as well as chemical reservoirs 40 (described in more detail below).

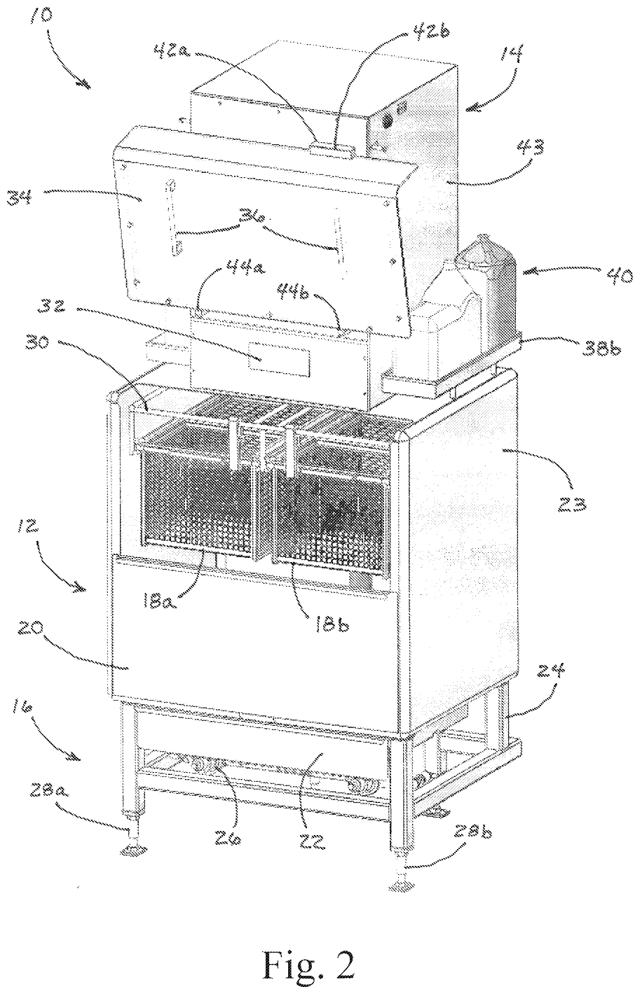

Product basket, separator & lid assemblies 18a & 18b (see FIG. 2) are vertically supported within immersion chamber 12 by product basket support structure 30. Access to product basket, separator & lid assemblies 18a & 18b is through an upper front opening in immersion chamber cabinet 23. In this preferred embodiment, the opening is covered during use by a removable transparent immersion chamber cover 34. Immersion chamber cover handles 36 allow the user to easily move immersion chamber cover 34 from a position closing off immersion chamber cabinet 23 during use, to a parking position against lift system cabinet 43.

When immersion chamber cover 34 is removed and parked, the user has access to product basket, separator & lid assemblies 18a & 18b for purposes of inserting product therein or removing product therefrom. In the parked position, immersion chamber cover 34 rests on immersion chamber cover support brackets 44a & 44b and is removably held to the front of lift system cabinet 43 through the interaction between immersion chamber cover magnet 42c and the immersion chamber cover which becomes magnetically attached to the front of the lift system 14 housing. With immersion chamber cover 34 in either position, user touch screen interface 32 remains visible and accessible to the user. As described in more detail below, this control display is preferably a touch screen display that allows the user to select and control the various automated functions of the immersion system.

Positioned on either side of lift system cabinet 43 are chemical reservoir shelves 38a & 38b which support a number of chemical reservoirs 40. As described below, various chemicals may be injected into the water flow associated with product washing functions and cleaning in place (CIP) functions. Flexible flowlines (not shown) will typically conduct chemical fluids from chemical reservoirs down to the water inlet, fluid flow & chemical systems 16 where the chemicals are selectively injected into the water flow. Positioning the chemical reservoirs 40 above the injectors in water inlet, fluid flow & chemical systems 16 allows gravity to assist with the flow of chemicals.

Immersion system 10, especially cabinets 23 & 43, is preferably constructed of stainless steel, as is typical of systems used in sanitary environments such as commercial kitchens and the like. Flow lines, valves, and injectors are preferably resistant to degradation over time from exposure to moderately caustic chemicals. Because the flow lines, valves, and injectors will periodically require cleaning and sanitizing, water inlet, fluid flow & chemical systems 16 is specifically structured with valve & chemical systems access drawer 22 to allow the user to position all such components for cleaning and sanitizing without the need to remove panels or otherwise take the system apart.

Reference is next made to FIG. 2 which is a perspective view of the self-contained embodiment of the present invention shown in FIG. 1 with product baskets raised and immersion chamber cover removed and “parked” for product basket access. Once again, the stand-alone immersion system 10 is shown to be generally constructed of three vertically stacked sub-systems. Water inlet, fluid flow & chemical systems 16 houses flow lines and valves and forms the support base for the entire system. Above fluid flow system 16 is immersion chamber 12 which provides the volume of fluid tank 20 as well as the open volume above tank 20 where the porous containers (product basket, separator & lid assemblies 18a & 18b) are positioned to receive and support the product being handled. Positioned on top of immersion chamber 12, and connected internally through the operational mechanical linkages described below, is lift system 14 which houses the mechanics of the lifting and immersing system as well as the electrical power components and the electronic control components.

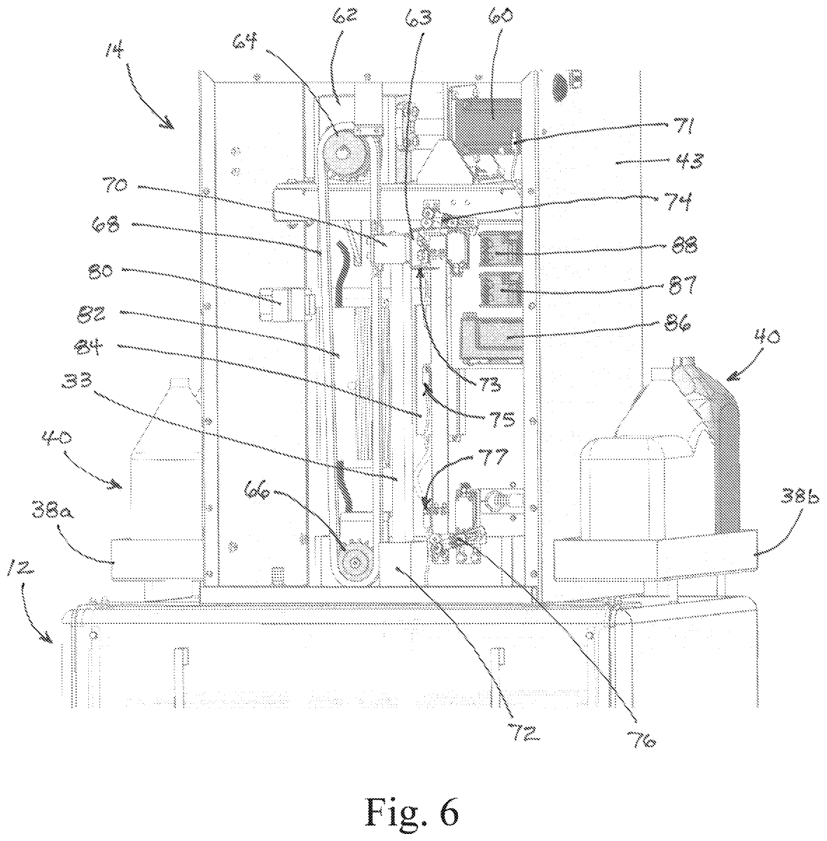

When immersion chamber cover 34 is removed and parked as shown in FIG. 2, the user has access to product basket, separator & lid assemblies 18a & 18b for purposes of inserting product therein or removing product therefrom. In this position, immersion chamber cover 34 rests on immersion chamber cover support brackets 44a & 44b. The immersion chamber cover 34 incorporates components 42a & 42b that interact with sensors in the cabinet (not visible in FIG. 2) to act first as an operational safety switch and second to confirm placement of the cover in the open parked position. Safety switch magnet 42a on immersion chamber cover 34 is detected in the cover closed position (see FIG. 1) by an aligned sensor within the lower portion of lift system cabinet 43. Immersion chamber cover sensor magnet 42b (which may be the same as or proximate to safety switch magnet 42a) on immersion chamber cover 34 is detected in the parked position (FIG. 2) by an internal sensor described below with FIG. 6. Once again, with immersion chamber cover 34 in the parked position, user touch screen interface 32 remains visible and accessible.

With immersion chamber cover 34 removed and parked as in FIG. 2, the components movably positioned within immersion chamber 12 sub-system are visible. Product basket, separator & lid assemblies 18a & 18b, which are supported above fluid tank 20 within immersion chamber cabinet 23, are held in position within immersion chamber 12 by product basket support structure 30. Access to product basket, separator & lid assemblies 18a & 18b is through this opening in immersion chamber cabinet 23 with the product baskets preferably constructed so as to slide forward and open to allow product to be placed into or removed from the baskets. While the preference is to have product baskets with at least porous bottoms and lids to facilitate vertical flow through, it is possible to optimize flow through rate for particular types of product where some walls of the product baskets are not as porous. In general, it may also be preferable for the product baskets to include porous lids and porous dividers that serve to separate the products Immersion chamber cover handles 36 allow the user to easily move immersion chamber cover 34 from immersion chamber cabinet 23 during use, to the parked position on lift system cabinet 43 as shown in FIG. 2.

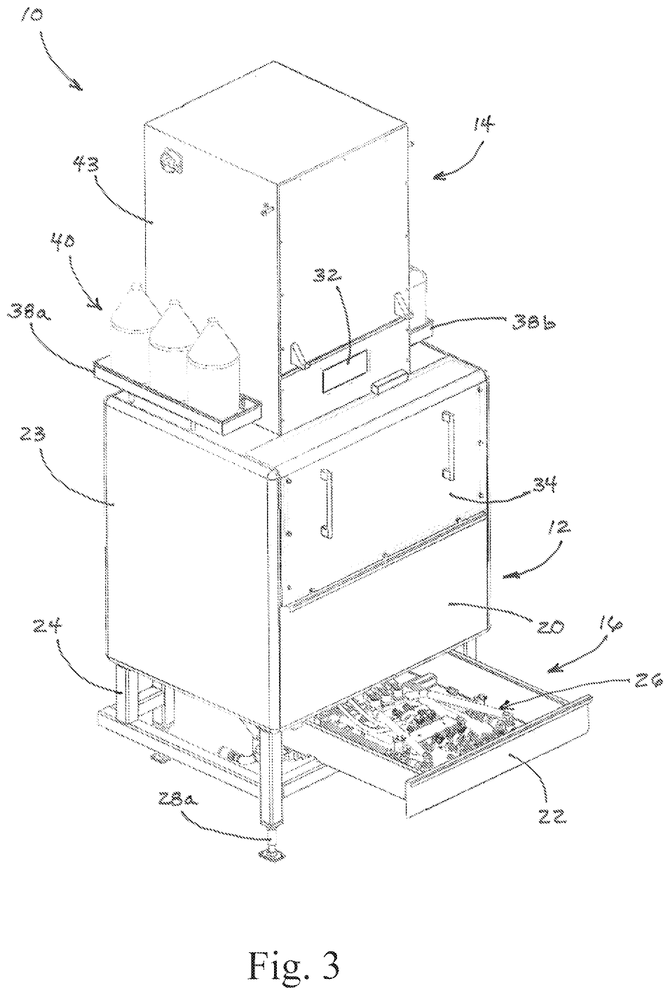

FIG. 3 is a perspective view of the self-contained embodiment of the present invention shown in FIG. 1 with product baskets raised, the immersion chamber cover in place, and the valve and chemical systems access drawer open. As indicated above, the flow of fluids into fluid tank 20 is carried out by the flowline valves 26 positioned within water inlet, fluid flow & chemical systems 16. This sub-system that forms the base of the overall immersion system 10 is shown in FIG. 3 supported on base frame 24 which includes an array of leveling legs 28a-28d (28a visible in FIG. 3). Importantly, the flow and fluid composition control components in water inlet, fluid flow & chemical systems 16 are made accessible by being positioned in valve & chemical systems access drawer 22 which, in FIG. 3, is shown extended out from base frame 24. Additional flowlines and connectors are positioned within water inlet, fluid flow & chemical systems 16 below valve & chemical systems access drawer 22 and are connected by flexible flow lines (not visible in FIG. 3). These additional flowlines and connectors serve to connect the overall immersion system 10 to incoming water lines (not shown in FIG. 1) as well as chemical reservoirs 40 (described in more detail below).

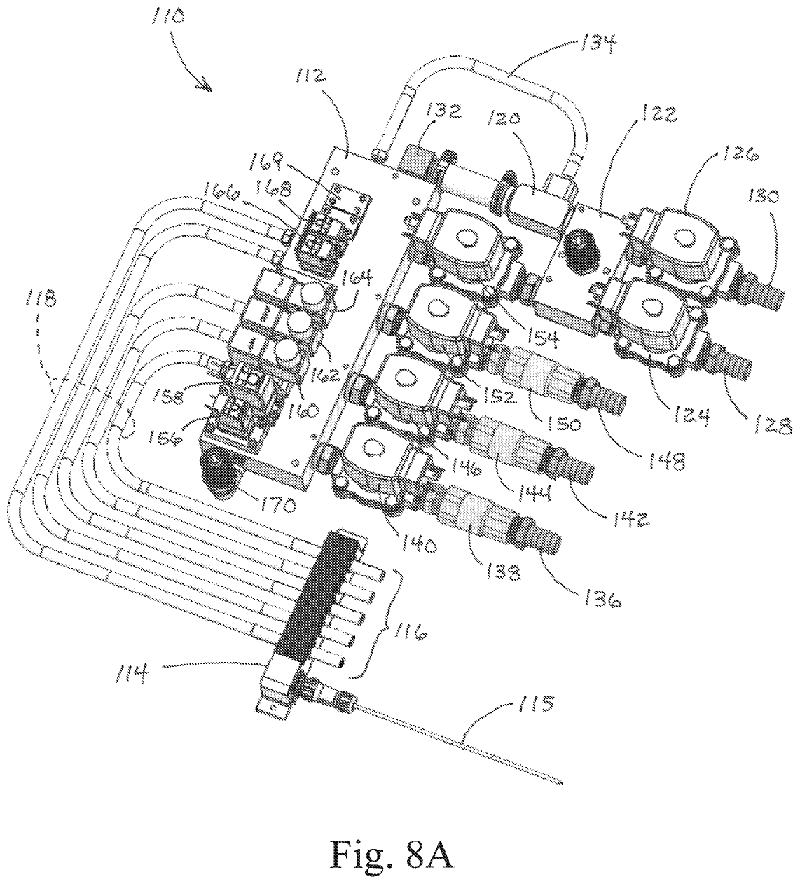

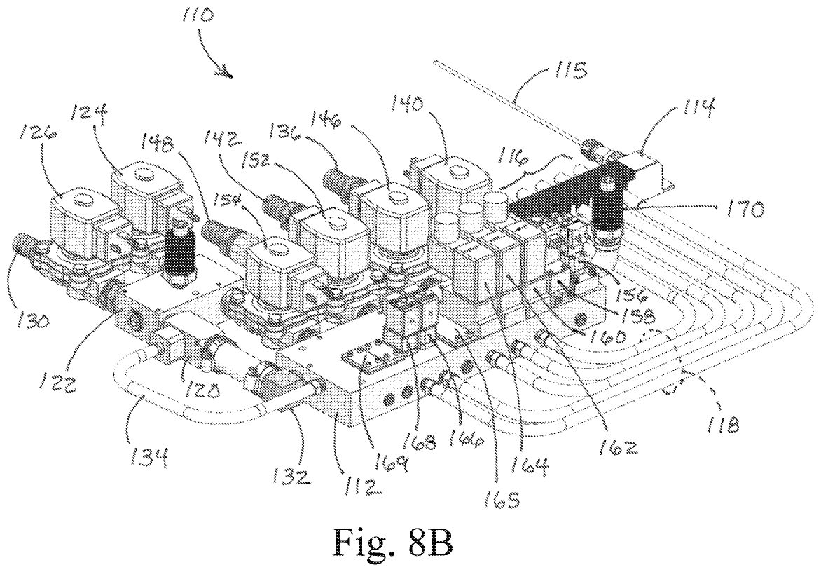

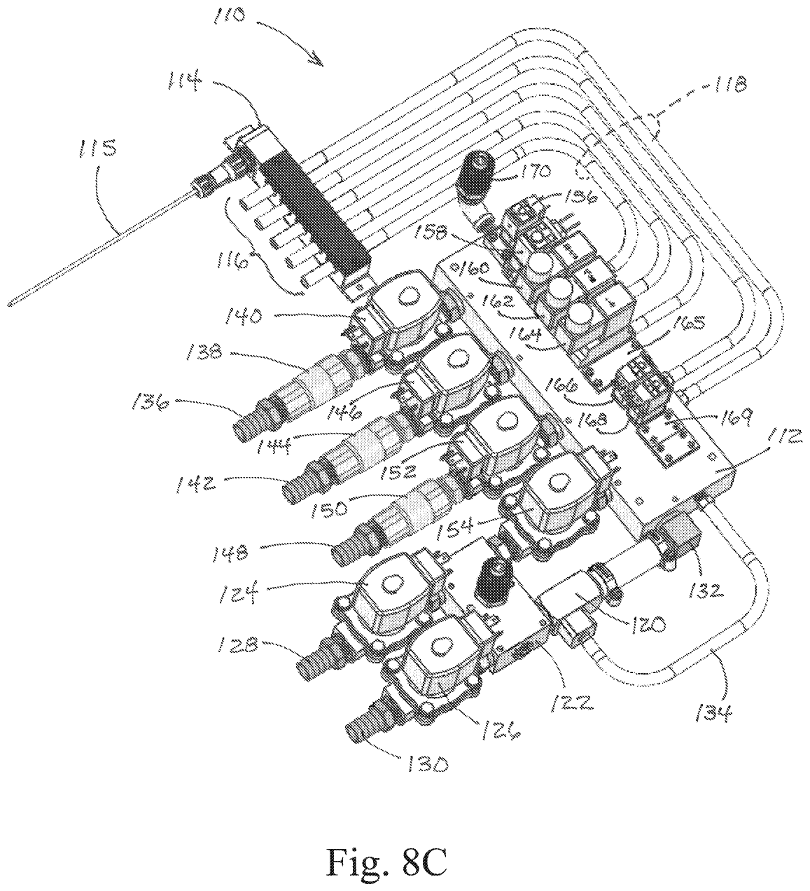

The ready accessibility of the flow and fluid composition control components in water inlet, fluid flow & chemical systems 16 positioned in valve & chemical systems access drawer 22 not only facilitates cleaning and maintenance of the overall system but also provides the ability to customize the use of chemical additives within the water used in both the immersive washing operation and in the cleaning in place (CIP) operation. As described in more detail below with reference to FIG. 8, the valves, injectors, and flowlines associated with all operational functions of the system are arranged for easy access and identification in access drawer 22.

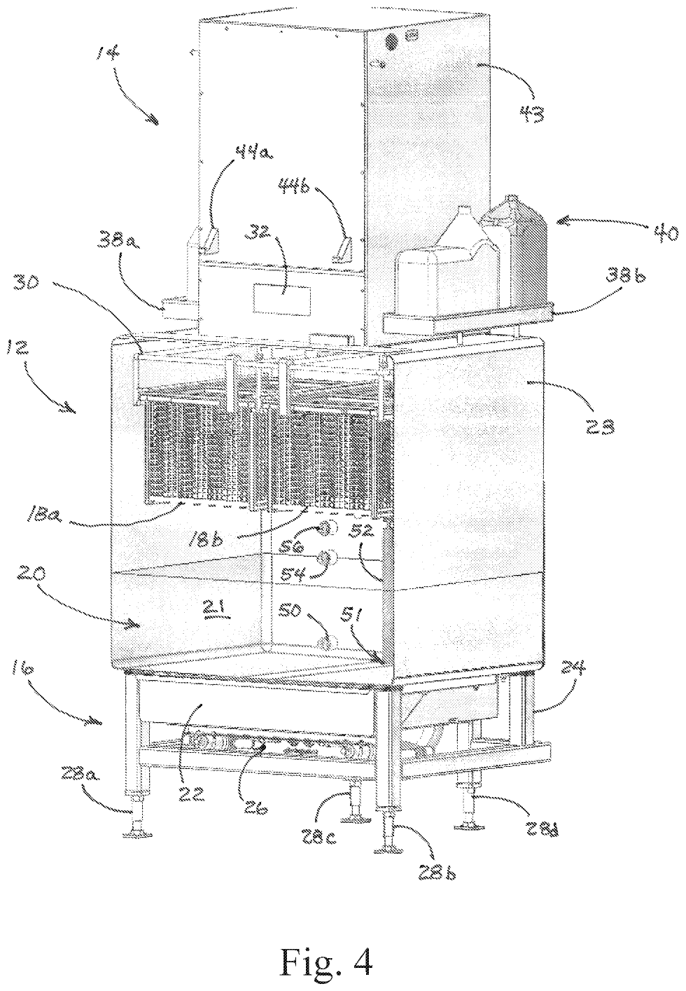

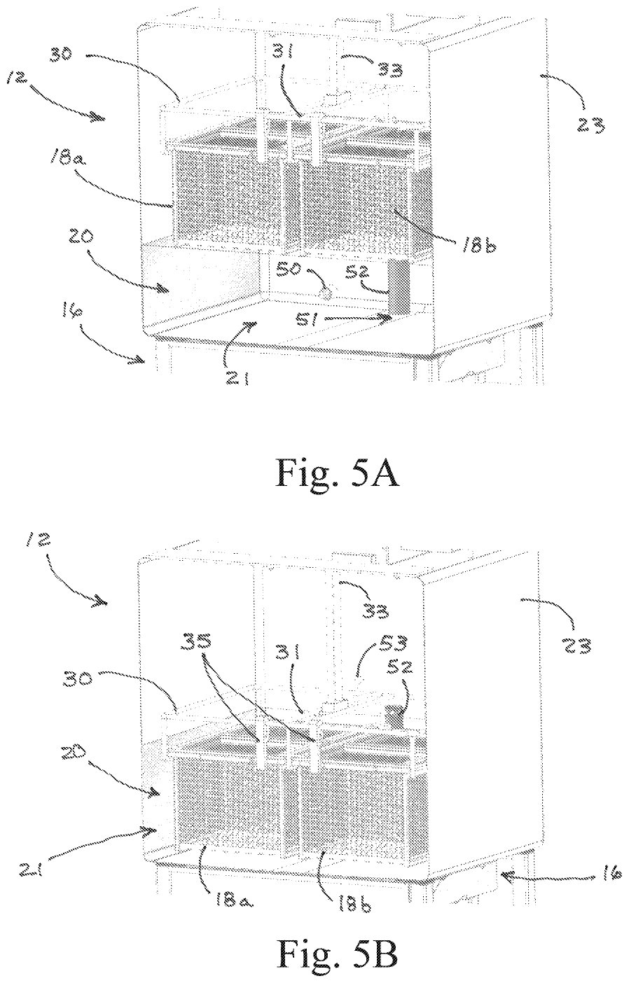

Reference is next made to FIG. 4 which provides a partial cutaway perspective view of the self-contained embodiment of the present invention shown in FIG. 1 with product baskets raised, the immersion chamber cover removed, and the front of the immersion chamber removed for clarity. In combination with FIGS. 5A & 5B, FIG. 4 discloses the manner in which product positioned within product basket, separator & lid assemblies 18a & 18b is repeatedly (and automatically) immersed into and raised from wash fluid 21 held in fluid tank FIG. 4 shows a first “load/unload” positioning of product basket, separator & lid assemblies 18a & 18b. FIG. 5A shows a second “top of cycle” positioning of product basket, separator & lid assemblies 18a & 18b. FIG. 5B shows a third “bottom of cycle” positioning of product basket, separator & lid assemblies 18a & 18b. Each programmed operation of the system takes the product baskets through these sequential positioning steps or portions of these steps.

As shown in FIG. 4, positioned within immersion chamber 12 sub-system are product basket, separator & lid assemblies 18a & 18b supported above fluid tank 20 within immersion chamber cabinet 23. Fluid tank 20 is filled with wash or thawing fluid 21 which comprises water or a water/chemical solution according to the function the system is operating through with the particular product being handled. As described above, fluid tank 20 is filled through an array of flowlines and control valves, again operated according to the specific functionality required. It is contemplated that the system can also be drained automatically by way of optional equipment and electromechanical systems.

Product basket, separator & lid assemblies 18a & 18b are held in position within immersion chamber 12 by product basket support structure 30. This support structure 30 is itself held in position by lifting rods (not visible in FIG. 4) that extend up into lift system 14. Control over the filling of wash fluid 21 within fluid tank 20 is facilitated by sensors and drains within the tank. Temperature, total dissolved solids & fluid low level sensor 50 is positioned near the bottom of fluid tank 20 to provide relevant information for the automated (or manual) filling of the tank. Temperature, total dissolved solids & fluid mid-level sensor 54 is positioned at what would typically be the surface of wash fluid 21 within fluid tank 20 to also provide relevant information for the operational readiness of the tank. Temperature, total dissolved solids & fluid high level sensor 56 is positioned at what would typically be just below the surface of wash fluid 21 within fluid tank 20 and primarily acts as a sensor to prevent overfilling of the system. Acting as a failsafe to an overfill event, standpipe overflow 52 is removably positioned over drain connection 51 within fluid tank 20. Overflow 52 also acts as an overflow drain when the fluid tank 20 is freshened and excess fluid must be drained out of fluid tank 20.

Once again, FIG. 5A shows the top of cycle positioning of product basket, separator & lid assemblies 18a & 18b while FIG. 5B shows the bottom of cycle positioning. FIG. 5A is a partial cutaway perspective view of the immersion chamber portion of the self-contained embodiment of the present invention shown in FIG. 1 with product baskets raised to the level of the wash fluid and the front of the wash chamber removed for clarity. In this view, product basket, separator & lid assemblies 18a & 18b are more clearly shown as they are positioned on product basket support structure 30. This support structure 30 is an open frame structure designed to slidingly receive and retain product basket, separator & lid assemblies 18a & 18b from the front of the assembly. Support structure 30 includes product basket support structure cross member 31 by which it is held in position (and raised and lowered) by lifting rods 33 that extend up into lift system 14. Temperature, total dissolved solids & fluid low level sensor 50 is also seen in FIG. 5A positioned near the bottom of fluid tank 20, as are drain 51 and standpipe overflow 52. These components (as well as sensors 54 & 56 not visible in FIG. 5A) are positioned at the rear of fluid tank 20, well away from product basket, separator & lid assemblies 18a & 18b and their associated support structure whether in the elevated positions shown in FIGS. 4 & 5A or the lowered position shown in FIG. 5B.

FIG. 5B is also a partial cutaway perspective view of the immersion chamber portion of the self-contained embodiment of the present invention shown in FIG. 1, but in this view the product baskets are fully lowered into to the wash fluid. In this view, product basket, separator & lid assemblies 18a & 18b are again clearly shown as they are positioned on product basket support structure 30. Support structure 30 includes product basket support structure cross member 31 that is secured to the lower end of lifting rods 33 that extend up into lift system 14. In FIG. 5B, lifting rods 33 have been further lowered into immersion chamber 12 from their upper end connection within lift system 14 (see FIG. 6 described below).

Also visible in FIG. 5B is fluid tank fluid inlet 53 which, like level sensors 50, 54 & 56 and standpipe overflow 52, is positioned near, on or through the back wall of immersion chamber cabinet 23 where it will not interfere with the travel of product basket, separator & lid assemblies 18a & 18b. Further identified in FIG. 5B are product basket retention clips 35 that serve to prevent product basket, separator & lid assemblies 18a & 18b from sliding or lifting out of support structure 30. Retention clips 35 may be easily flipped out of the way by the user when accessing the baskets for the purpose of inserting or removing product. In the preferred embodiment product basket, separator & lid assemblies 18a & 18b may be slid entirely out from support structure 30 where they may be filled or emptied of product outside of the system 10. In this manner, as many as four or six removable product basket, separator & lid assemblies may be inserted into and supported by support structure 30. While the height and width of these basket assemblies may be fixed by the height of the immersion tank (and the vertical travel of the system) and the width of the support structure, the depth (into the cabinet) of each assembly can vary according to whether there is one (one that spans the entire support structure 30), two (one on each side of the support structure 30), four (two on each side), or six (three on each side). Larger systems could, of course, accommodate additional basket assemblies. Smaller systems could, of course, utilize a single basket assembly.

FIG. 6 is a perspective view of the interior of the lift system portion of the self-contained embodiment of the present invention shown in FIG. 1 with the front of the lift system cabinet removed for clarity. Lift system 14 is positioned above immersion chamber 12 with an opening between that allows for the passage of lifting rods 33 between the two cabinets. As indicated above, the positioning of lift system 14 maintains all high voltage electrical elements and most low voltage components above and removed from the wet environment of immersion chamber 12. Low voltage control lines that extend down to water inlet, fluid flow & chemical systems 16 pass external to immersion chamber 12 and require no extraordinary waterproofing as would be required with higher voltage conductors.

Within lift system cabinet 43 are the mechanical, electrical, and electronic components that produce the vertical motion of lifting rods 33 and therefore the cyclic immersion and extraction of product from the wash fluid in the fluid tank. Lifting rods 33 extend from lifting rod head 70, through lifting rod guide & bushing 72, to a point of fixed attachment on product basket support structure cross member (see 31 in FIGS. 5A & 5B). Lifting rod head 70 is fixed to a point on drive chain/belt 68 and therefore raises and lowers lifting rods 33 as drive chain/belt 68 moves. Drive chain/belt 68 fits around follower sprocket 66 and gear box drive sprocket 64. Drive sprocket 64 rotates on the output axis of gear box 62 which in turn is driven on its input axis by drive motor 60. Drive motor 60 is preferably a DC step motor capable of accurately and incrementally moving drive chain/belt 68 in either direction. The necessary torque required for lifting the modest loads (product contained within the product basket assemblies) can more than adequately be achieved through appropriate gear reduction through the gear box 62.

Fixed to the back side (the side opposite its attachment to drive chain/belt 68) of lifting rod head 70, are sensor magnet 63 and a travel limiting switch contact arm. Sensor magnet 63 interacts with three linearly spaced sensors 73, 75 & 77 along the vertical path of the lifting rod head 70 as the lifting rods 33 move. Load unload position sensor 73 marks the uppermost normal travel of the system with the product basket, separator & lid assemblies 18a & 18b positioned for loading or unloading product. Top of cycle sensor 75 and bottom of cycle sensor 77 mark the upper and lower travel limits for the cyclic immersion and extraction of the product basket, separator & lid assemblies 18a & 18b during normal immersion operation. These sensors 73, 75 & 77 inform the controller of the positioning of the product during operation and facilitate such motion through preprogrammed procedures specific to the various tasks the system is capable of. A similar magnetic sensor, immersion chamber cover sensor 71, is positioned to detect when the immersion chamber cover (not shown in FIG. 6) is in the parked position as described above. A further sensor (not visible in FIG. 6) is positioned internally near the interface between immersion chamber 12 and lift system 14 to detect when the immersion chamber cover is in place as with operational use of the system.

Also positioned adjacent to the extreme ends of travel for lifting rod head 70 are upper limit overtravel switch 74 and lower limit overtravel switch 76. Beyond simply identifying position, these switches 74 & 76 prevent the motor from driving the drive chain/belt beyond its safe limits. In addition to the above described mechanical and electromechanical components positioned with lift system cabinet 43, there are a number of electrical and electronic components that power and control the operation of the system. Power convertors 82 & 84 provide the necessary AC to DC conversion to power the DC motor, the valve actuators, and the electronics associated with the programmable microcontrollers within the system. Emergency power cut off switch 80 is also provided and is accessible to the user from outside of lift system cabinet 43.

Control of the operation of the overall system is achieved through the use of universal programmable controller 86, motor controller/pressure sensor module 88 and power cut off relay module 87. Universal programmable controller 86 operates in response to preprogrammed routines and user input from the user touch screen interface (not shown in FIG. 6). Universal programmable controller 86 further receives sensor input from each of the various mechanical, magnetic, and chemical sensors described above and below. Universal programmable controller 86 further directs the operation of drive motor 60 as well as the operation of various valve actuators within the system through controller modules 87 & 88.

There is generally little need for user access to the above described components within lift system cabinet 43. Other than during cleaning in place (CIP) operation, no water, fluids, or chemicals flow within the closed lift system cabinet 43, with the only exchange with the wet environment of the immersion chamber being the movement of the “dry” portion of the lifting rods 33 up into the cabinet. Lifting rod guide/bushing 72 serves to minimize moisture travelling up into the cabinet with the movement of the rods. Although chemical reservoirs 40 are positioned on chemical reservoir shelves 38a & 38b adjacent the cabinet, the flow lines from these reservoirs are external to the cabinet and travel down the back and/or the external sides of the system to the chemical injectors positioned in the water inlet, fluid flow & chemical systems 16 near the base of the unit.

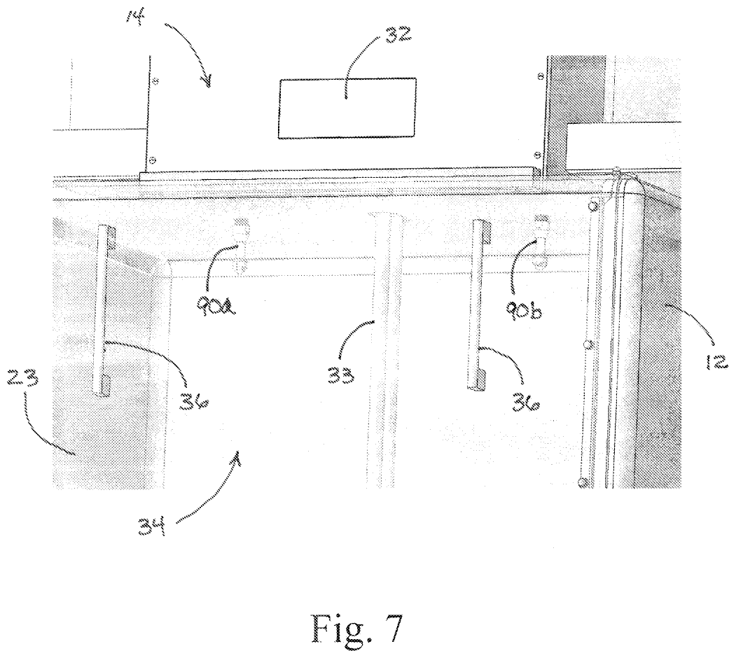

FIG. 7 is a detailed perspective view of the upper immersion chamber portion of the self-contained embodiment of the present invention shown in FIG. 1 with the product baskets lowered out of view for clarity and discloses a few additional components in the system specifically related to the cleaning in place (CIP) functionality. At the interface between immersion chamber 12 and lift system 14 is where CIP (clean in place) nozzles 90a & 90b are positioned and extend into immersion chamber 12 (the upper part of immersion chamber cabinet 23). Operation of the CIP functionality would, of course, occur with immersion chamber cover 34 (fitted with immersion chamber cover handles 36) as shown in FIG. 7. CIP functionality may be carried out with or without product basket, separator & lid assemblies 18a & 18b in place and with the product basket support structure 30 in any position within the chamber including actively cycling up and down.

Reference is next made to FIGS. 8A-8B for detailed perspective views of the water inlet, fluid flow and chemical systems of the self-contained embodiment of the present invention shown in FIG. 1 with some connecting water and chemical flow lines removed for clarity. As indicated above, most of the water and chemical flow lines of the system are collected well away from the electrical and electronic components of the system, predominantly in the water inlet, fluid flow & chemical systems 16, and more specifically within valves & chemical system access drawer 22. In the orientation of FIG. 8A, the external drawer face is positioned to the left of the drawing with the flow lines that are represented in the figure extending to the back and below the drawer.

FIGS. 8A-8C are detailed perspective views of the water inlet, fluid flow and chemical system of the present invention. Chemical & fluid flow control system 110 includes a centralized manifold 112. Chemical sensor module 114 monitors the chemicals in each of the chemical inlet lines 116. Electronic signal line 115 carries the chemical status data back to the system controller. From sensor module 114, chemical flow lines 118 carry the chemicals (typically fluid flow) to the chemical inputs side of manifold 112.

The water inputs side of manifold 112 includes hot water connector (inlet port) 136 with hot water check valve 138 and hot water solenoid valve 140. Parallel to the hot water inlet is chilled water connector (inlet port) 142 with chilled water check valve 144 and chilled water solenoid valve 146. Parallel to the chilled water inlet is cold water connector (inlet port) 148 with cold water check valve 150 and cold water solenoid valve 152.

The outlets of manifold 112 include manifold outlet (water) 132, manifold outlet (chemical mixes) 134, and a water bypass port through water bypass solenoid valve 154. Water from outlet 132 and chemical(s) from outlet 134 flow through inductor unit 120 where they are mixed. The combination then flows through pressure sensor (0-100 psi) 122 through either or both of fluid spray jets solenoid valve 124 and fluid tank fill solenoid valve 126. Fluid jets connector (outlet port) 128 directs the fluid combination to the spray jets described above and fluid tank connector (outlet port) 130 directs the fluid combination to the enclosed tank described above.

The chemical flow through manifold 112 is controlled by the bank of valves positioned on the chemical inlet side of the manifold. These include chemical valves 160, 162, 164, 166, and 168 as well as expansion chemical valve positions 165 & 169. Also connected to and positioned on the chemical inlet side of manifold 112 are diluent bleeder solenoid valve 156 and flush out solenoid valve 158 which facilitate the reset and re-home processes of the system. Vacuum sensor 170 monitors the manifold suction on the chemical lines which provides the mixing (induction) of the chemicals into the water flow without the need for pumps of the like.

There are basically three incoming and two outgoing water lines in water inlet, fluid flow & chemical systems 110. The hot water, cold water, and chilled water lines are ultimately connected to standard external hot, cold, and chilled water sources and bring water into the system in a controlled manner through the respective electrically actuated water valves. The check valves protect the internal flow system. The fluid jets connection and fluid tank connection distribute water (and chemicals in solution as necessary) out from water inlet, fluid flow & chemical system out to the operational enclosure portion of the overall wash system.

Chemical flow lines have also been omitted for clarity in FIGS. 8A-8C but involve a number of inlet tubes or lines (five in the embodiment shown in FIGS. 8A-8C) that bring the respective chemical concentrated solutions from the chemical reservoirs 40, through chemical sensor module 114, to the individual input ports in manifold 112. Chemical sensor module 114 is an optical sensor that detects and confirms the flow of a specific chemical concentrate through the module to the respective injector. As indicated above, such chemical flow only occurs when a specific valve directs a flow of water through the connected injector, eliminating the need for chemical solution pumps or valves.

The chemical dispensing system described above provides a unique, universal, accurate titration, flexible, chemical delivery system. The primary requirement for this flexibility is the assurance that the chemical is being delivered at the correct rates without regularly sending a service person to check, clean or adjust the system. Many common chemical dispensing systems drift on their titration rates over periods of time. Metering orifices clog, peristaltic pumps reduce in volume and then fail. Being able to always deliver the precise amount of chemical each and every time has a very high value to the end user. There is little or no chance of over or under dispensing.

In addition, the chemical system of the present invention provides the ability to blend technologies so as to provide an engine that will always deliver very low to very high titration rates without additional energy or maintenance. The system offers the ability to change from one chemical to another via a soft adjustment and to reliably deliver the exact amount of chemical to any location within the overall system. The system reliably delivers the exact amount of chemical to match a required flow rate with a matched titration rate across many chemicals. The system has the ability to automatically clean the overall system between chemicals dispensing events and to perform typical maintenance automatically a series of components versus requiring the intervention of a person.

The system will test every time a chemical is dispensed and will report success or failure of the action. Additionally, there is the ability to live report that the correct chemical is being dispensed and to adjust chemical parameters by way of a software profile. The system is capable of adjusting a chemical due to changes in fluid temperature and to deliver pure water or clean fluid to multiple locations. In addition, the system provides an automated bypass of the dispensing system for faster filling. The fluid control system is generally adaptable to adjust fluid temperature as needed and to manage chilled or super-heated fluids.

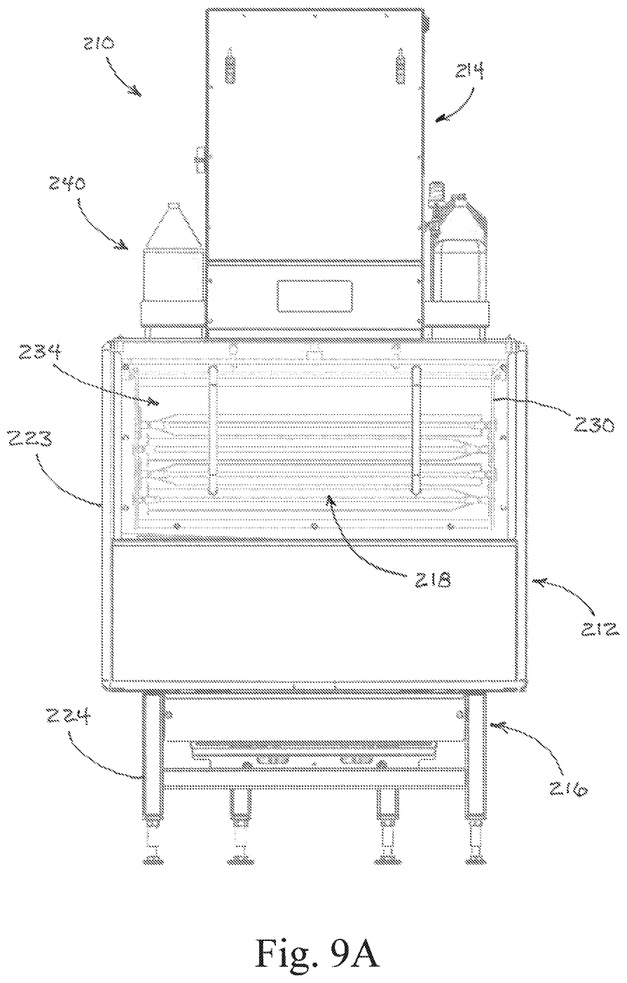

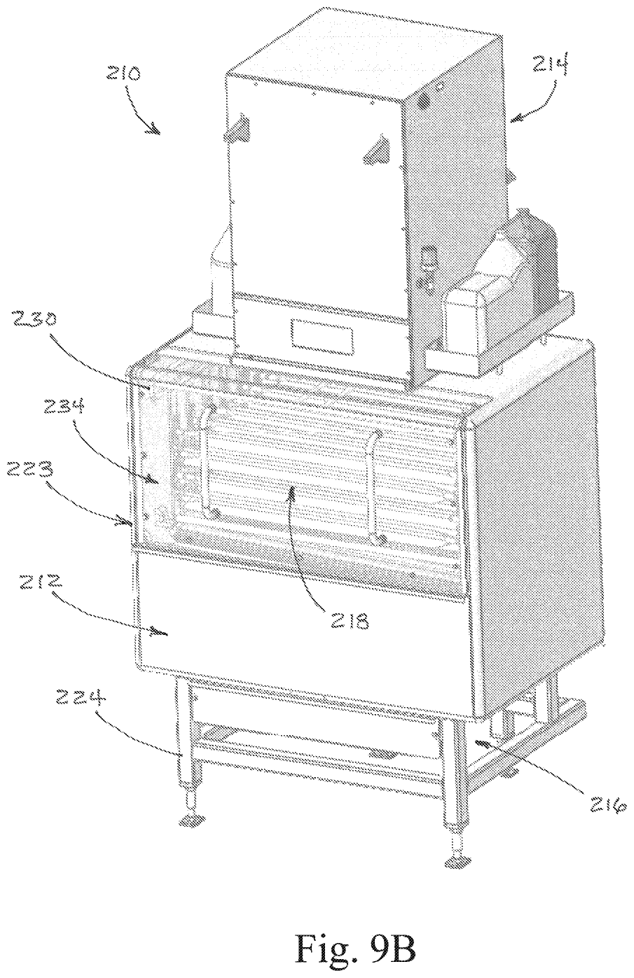

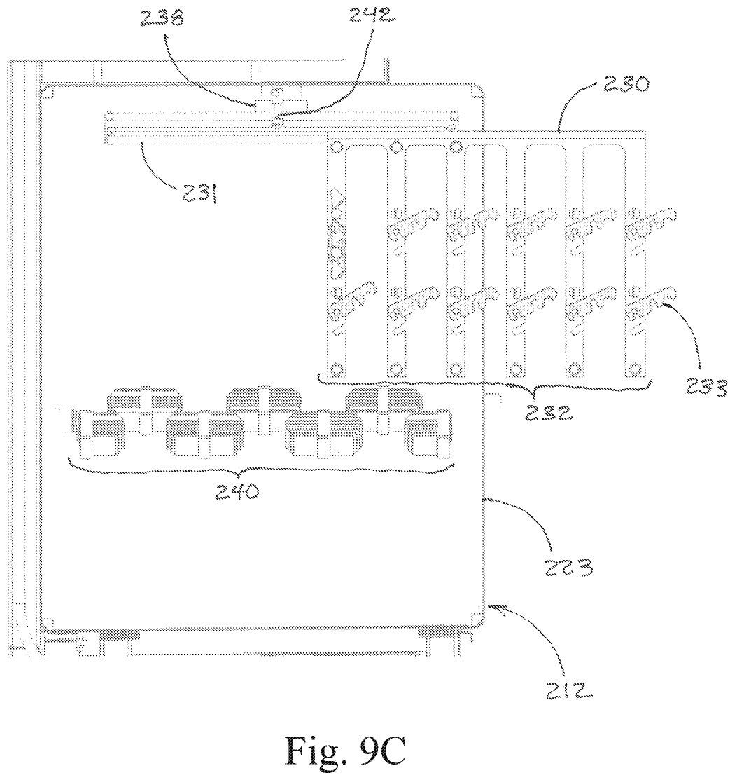

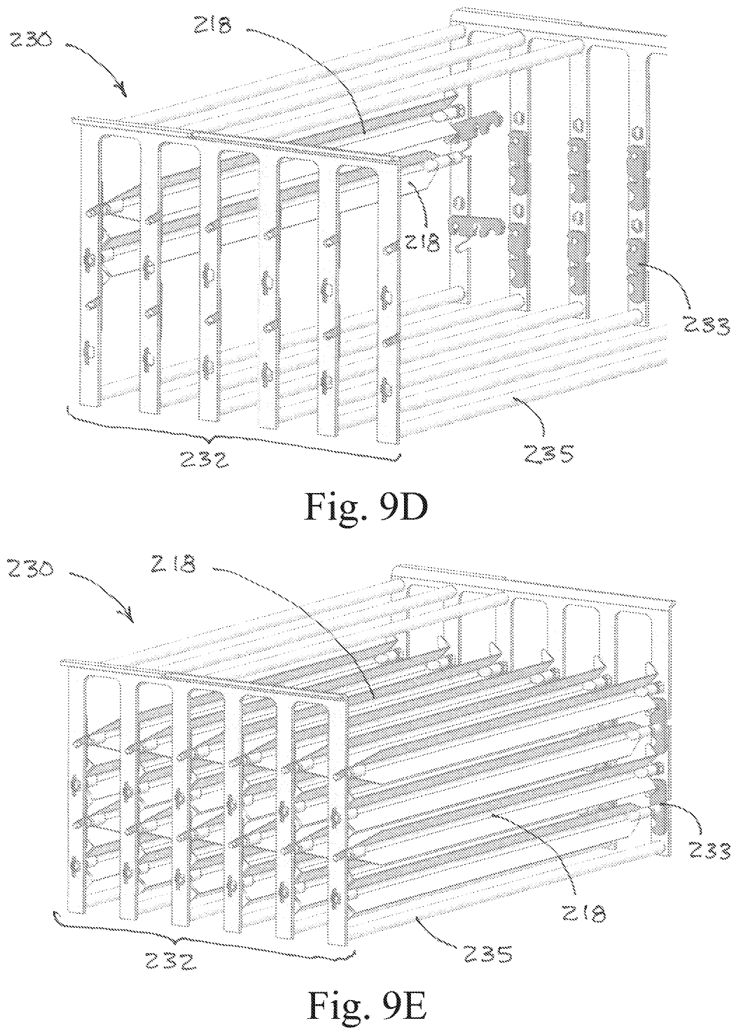

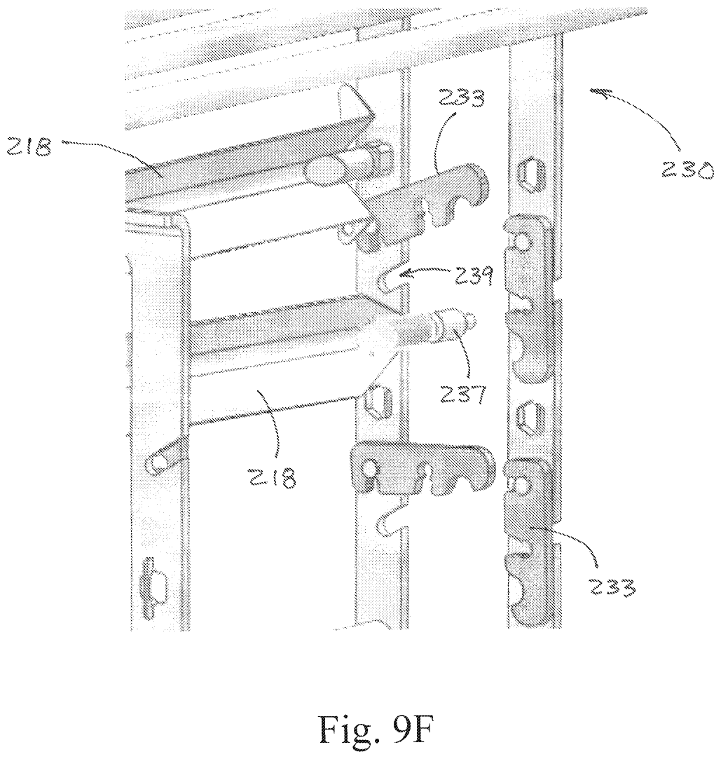

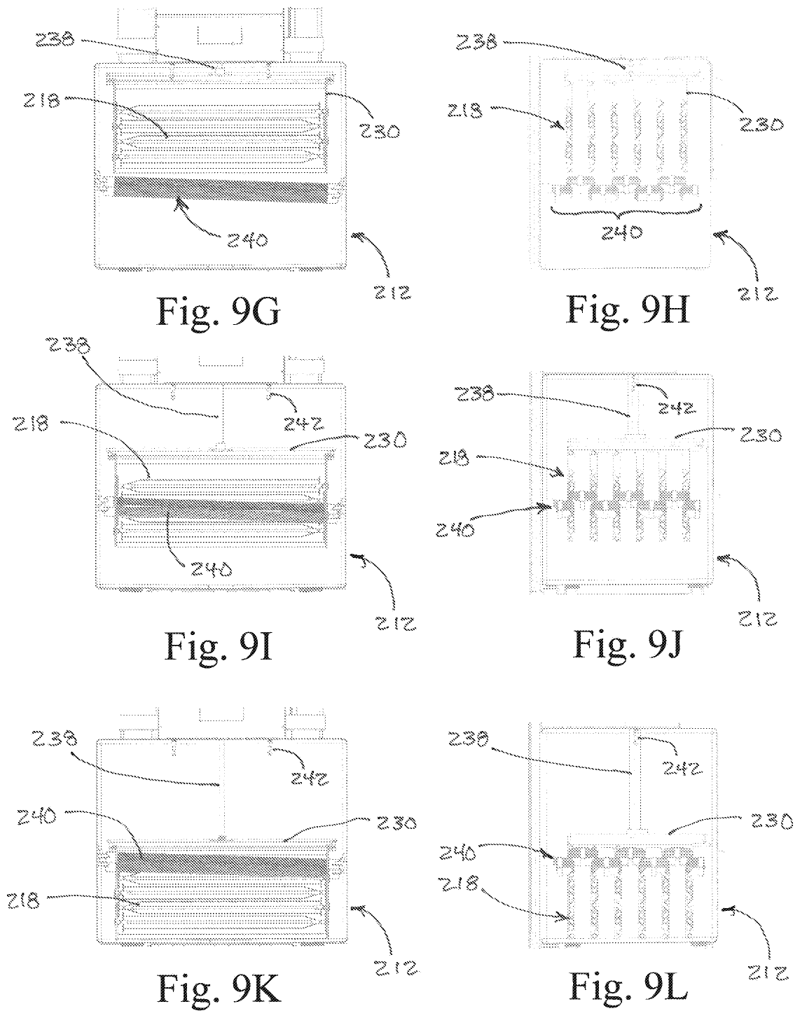

FIGS. 9A-9L show an alternate embodiment of the present invention structured to receive and wash skewers of the type typically used with rotisserie cooking of poultry and other meats. FIGS. 9A-9B are perspective views of an alternate embodiment of the present invention structured to hold and wash skewers and the like. This stand-alone immersion system 210 is generally constructed of three vertically stacked sub-systems. The base of the immersion system 210 is supported on frame 224 and positions water inlet, fluid flow & chemical systems 216 which primarily houses flow lines and valves typically with low voltage sensors and valve actuators. Above water inlet, fluid flow & chemical systems 216 is immersion chamber 212 which provides the physical volume of immersion chamber cabinet 223 to both hold the fluid into which the skewers are immersed and support the brushes that receive and clean the skewers during processing. Above immersion chamber 212 is lift system 214 which houses the mechanics of the lifting and immersing system as well as the electrical power components and the electronic control components. This stacked arrangement of the three primary sub-systems not only optimizes access by the user but also puts all high voltage electrical components, and most all sensitive electronic components, above the wet environment of the immersion chamber 212 for purposes of safety and reliability. Within immersion chamber 212 sub-system are positioned movable skewer rack 230 which holds a number of skewers 218 which are supported above the fluid tank within immersion chamber cabinet 223. In use, the fluid tank is filled with water or a water/chemical solution according to the function the system depending on the preprogrammed skewer washing process. Chamber cover 234 and chemical reservoirs 240 are as described in connection with the embodiment shown in FIG. 1.

The benefits of the system shown are many. The system is designed to save up to 80% on labor, chemicals, water & energy. The system is high capacity, holding as many as twenty-four skewers per load, enough to wash skewers from three unloaded ovens at one time. All washing, scrubbing, rinsing, and sanitizing functions occur inside the cabinet. No pre-washing is required, and no additional team member labor/handling is required upon cycle completion other than unloading. When a cycle completes a team member can unload and take the skewers to storage or directly to be loaded with new product. The system is fast with a cycle time of approximately eight to twelve minutes. The user may choose high temperature (180° F.) or chemical sanitizing. When using high temperature, a “cool down” mode eliminates humidity from being introduced into the room.

The system is fully automatic, with smart chemical dispensing. The system is intuitive, with easy-to-use touch screen control. The system is compact, with 50% less floor space required compared to other current washing systems. The system presents an ergonomic loading height with no bending over required for loading or unloading. No condensation hood above the unit is required. The system is programmed to be self-cleaning. A preferred embodiment of the system cabinet may be illuminated with ultrabright, efficient LED lights.

FIG. 9C is a partial cutaway view of the alternate embodiment of the present invention shown in FIG. 9A with the skewer rack 230 positioned above the brushes 240 and the water level in immersion chamber 212 and extended from the system for loading the skewers. Skewer rack 230 includes rack hangers 232 fitted with retention clips 233. Skewer rack 230 is supported on sliding brackets 231 which are in turn supported on lift assembly rod 238. Jet spray nozzles 242 are also disclosed in FIG. 9C, positioned to deliver a water/chemical mixture onto the skewers before and/or during the immersion cycle.

FIGS. 9D-9E are detailed perspective views of the skewer racks 230 of the alternate embodiment of the present invention shown in FIG. 9A showing the process of loading the skewers 218 into the skewer rack and retaining them in place with clips 233. Cross supports 235 on the top and bottom of skewer rack 230 are also shown in FIGS. 9D & 9E.

FIG. 9F is a detailed perspective view of the alternate embodiment of the present invention shown in FIG. 9A again showing the process of loading and securing the skewers 218 into the skewer rack 230. End posts (axles) 237 on the skewers 218 fit into slots 239 on hangers 232 and are held in place by retention clips 233.

FIGS. 9G-9L are front and side cutaway views of the alternate embodiment of the present invention shown in FIG. 9A showing the sequential process of lowering the skewers 218 (loaded into the skewer rack 230) through and between the brushes 240 and into the fluid filled tank of immersion chamber 212.

The system described in FIGS. 9A-9L utilizes a single structure to rack skewers to be processed. The rack does not get removed from the machine. The rack slides forward so that skewers can quickly and ergonomically be loaded into the back of the rack. As the rack becomes loaded the team member can simply slide the rack back into the system as they continue to load more skewers. Ultra-high molecular weight (UHMW) plastic press fit clips hold the skewers in place during cycling. Skewers load in an alternating pattern. While the system will wash up to twenty-four skewers, a full load is not required for processing to begin. The entire rack is preferably constructed of stainless steel. Ultra-high molecular weight (UHMW) track slides are preferred for the system so that the rack slides very smoothly.

Skewers are preferably coated with a chemical and water solution by way of the integrated, rotating spray jets, a process which may be repeated briefly as required. Skewers are repeatedly lowered and raised through angled brushes. Rinsing and sanitizing is completed using the systems integrated, rotating spray jets as the skewers continue to move through the brushes. Side views of skewer processing also shown in FIGS. 9H, 9J, and 9L. High heat sanitizing (180° F.) can be selected to further reduce chemical usage/costs. The system can intelligently switch between high heat and chemical sanitizing in the event a hot water shortage occurs for any reason. A compact electric on demand booster heater is required for high heat sanitizing. The system does not waste large amounts of chemicals and water by filling and charging a large tank with hot water and expensive chemicals. Instead, skewers are coated with the bare minimum of hot water and chemical mix required. This is true for both detergents and sanitizers. Since the system physically and aggressively scrubs all the surfaces of the skewers, they are fully clean when the cycle completes with no additional labor and handling required. Using the bare minimum of water, energy and chemicals while eliminating the secondary manual scrubbing and handling results in up to an 80% savings in all these areas. The system is self-cleaning, so no extra labor, energy or chemicals are required as there is no daily cleaning of the system for nightly shut down.

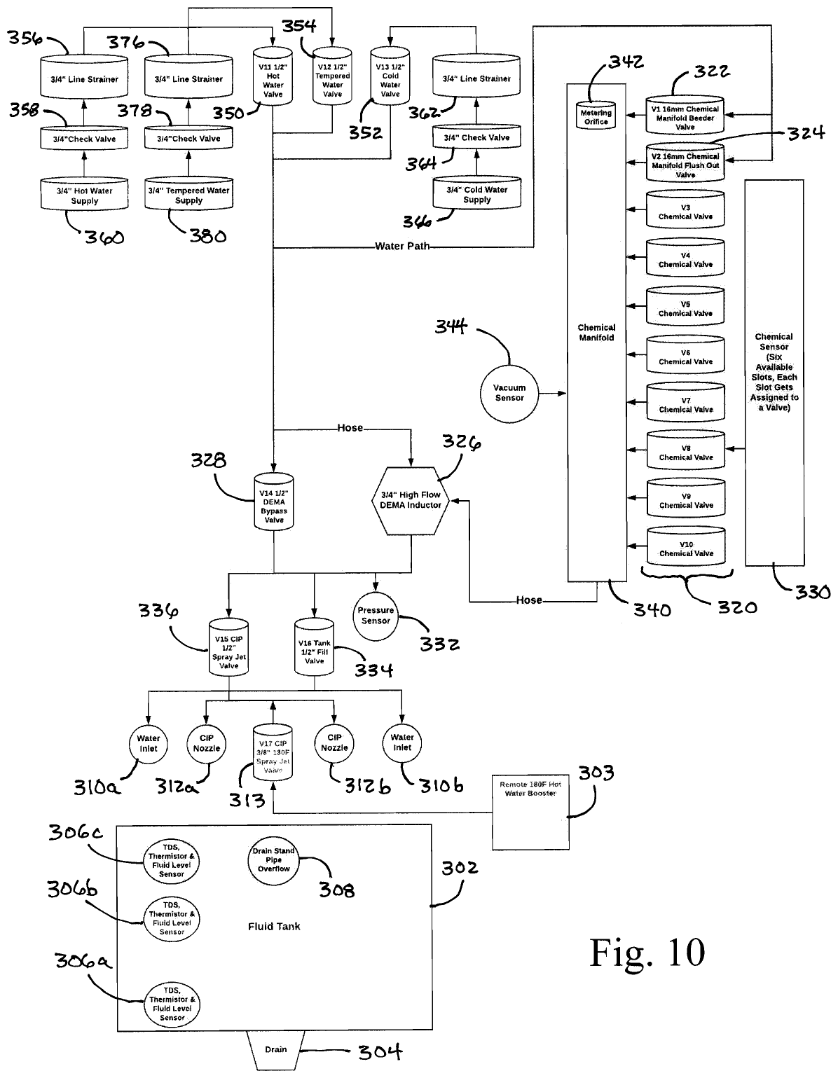

Reference is next made to FIG. 10 which is a schematic block diagram of the water inlet, fluid flow and chemical systems of the first embodiment of the present invention, generally tracking the structures shown in FIGS. 8A-8C. In this schematic block diagram form the figure provides the essential functionality of the water and chemical flow processes of the system of the present invention. With the arrays of sensors and electronically actuated valves the system facilitates both manual operation and automated operation according to a wide range of preprogrammed routines in both the product handling mode, the cleaning in place (CIP) mode, and the reset or re-home processing.

The water inlet, fluid flow, and chemical system as schematically set forth in FIG. 10, utilizes fluid tank 302 with fluid tank drain 304 (manual or controlled). Preferably included in fluid tank 302 are: temperature, total dissolved solids & fluid low level sensor 306a; total dissolved solids & fluid mid-level sensor 306b; and total dissolved solids & fluid high level sensor 306c. Stand pipe overflow 308 is also included in fluid tank 302 and may be separate from or incorporated with fluid tank drain 304.

Two fluid inlet or fill functions are provided into fluid tank 302. Fluid tank fluid inlets 310a & 310b provide the water or water/chemical solution called for in any of the product immersion handling functions of the system (washing, rinsing, deicing, thawing, etc.). CIP (clean in place) nozzles 312a & 312b provide the water or water/chemical solution called for in any of the CIP functions of the system or in any of the other processes that call for sprayed water or water/chemical solutions.

Water flow with or without chemical injection is, as described above, generally controlled by activation of various specific valves. Water into the system is provided as hot, tempered, and cold sourced from hot water supply 360, tempered water supply 380, and cold water supply 366. Check valves 358, 378, and 364 are provided on the hot, tempered, and cold water supplies respectively. Likewise, pressure regulator/line strainers 356, 376, and 362 are provided on each of the hot, tempered, and cold water supplies respectively. Flow of hot water into the system is controlled by hot water valve 350 while flow of tempered water into the system is controlled by tempered water valve 354, and flow of cold water into the system is controlled by cold water valve 352. Once again, these flow control valves are preferably electrically actuated valves. The hot, tempered, and cold water flowlines combine downstream of the inlet control valves giving the system the ability to run with hot water, tempered water, and/or cold water or a combination thereof.

In addition to being directed to the fluid tank enclosure, the flow of water is selectively directed as an input flow to chemical manifold bleeder valve 322 and to chemical manifold flush out valve 324. Most importantly, the flow of water is directed through high flow DEMA inductor 326 where it combines with any selected chemicals that are to be introduced into the flow. DEMA bypass valve 328 provides for bypassing the inductor to send “clean” water flow directly into the enclosure components (spray jets and/or fill tank). In either case, the water flow or the water/chemical flow is directed into the spray jets or tank fill components by way of spray jet valve 336 and tank fill valve 334. Water pressure sensor/transducer 332 is positioned upstream of the inlet control valves 334 & 336 to monitor inlet water pressure. A separate hot water booster feed is preferably provided including a remote 180° F. hot water booster source 303 with CIP spray jet valve 313 as shown.

On the product handling side of the system there are control valves for directing “clean” water flow towards fluid tank 302 and/or spray nozzles 312a & 312b. As indicated above, bypass valve 328 allows fresh water to flow directly into fluid tank 302 and/or spray nozzles 312a & 312b. Fresh water may be preferred for use with any of a number of functional modes including rinsing, thawing, deicing, and certain sensitive washing functions. Otherwise, the flow of water is directed through inductor 326 (as described above) before flowing into fluid tank 302 and/or spray nozzles 312a & 312b. A water/produce wash solution would be preferred for edible produce or other food products and could vary according to the specific chemicals accepted for food grade wash systems.

The chemical induction portion of the system (shown generally on the right hand side of FIG. 10) is scalable to accommodate a number of different chemicals and chemical combinations. As described above, it is through chemical sensor 330 that the flows of chemicals are introduced into the system. The array of chemical valves 320 allow for the designated chemicals to be drawn into the flow through the chemical manifold 340 with metering orifice 342. Vacuum sensor 344 monitors the negative pressure on the manifold, created by the inductor 326, that draws the appropriate chemical(s) into the water flow when the appropriate chemical valve(s) 320 are open.

The functionality set forth in schematic form in FIG. 10 may be implemented in whole or in part in any of the preferred embodiments of the present invention. The methods for passively injecting chemicals into water flow streams allow the system to function without complex chemical pumps and the like. By controlling fluid composition (with both the product handling and CIP functions) with separate electrically actuated valves the present invention eliminates much of the maintenance and repair typically required of such systems.

The methods of the present invention therefor involve the highly efficient immersion process as well as the reliable and efficient water/chemical solution control process. The basic process method for product handling (washing, deicing, rinsing, etc.) involves the steps of: (a) filling the fluid tank with the desired water or water/chemical solution; (b) positioning the product carrier assembly in a load/unload position; (c) loading product into the product carrier assembly; (d) lowering the loaded product carrier assembly into the filled fluid tank, thereby immersing the product in the fluid; (e) lifting the loaded product carrier assembly up from the filled fluid tank; and (f) repeating the lowering and lifting steps as needed.

The automated controls of the present invention as described above allow for controlled variations in the rapidity of the immersion and removal actions (which varies the force on the product by the fluid as the product passes through) as well as the number of repetitions. Programmed control can provide specific sequencing of different motion rates and repetitions. For example, the system might carry out an initial soak, pausing the motion after the product is immersed, before proceeding with a more rapid immersion/extraction cycling.

The automated controls of the present invention related to water temperature and chemical solution content add further versatility to the functionality and the many processes that the system can carry out. Optimal combinations of temperature, chemical content, motion speed, time and repetitions allow for highly efficient procedures for a myriad of different products.

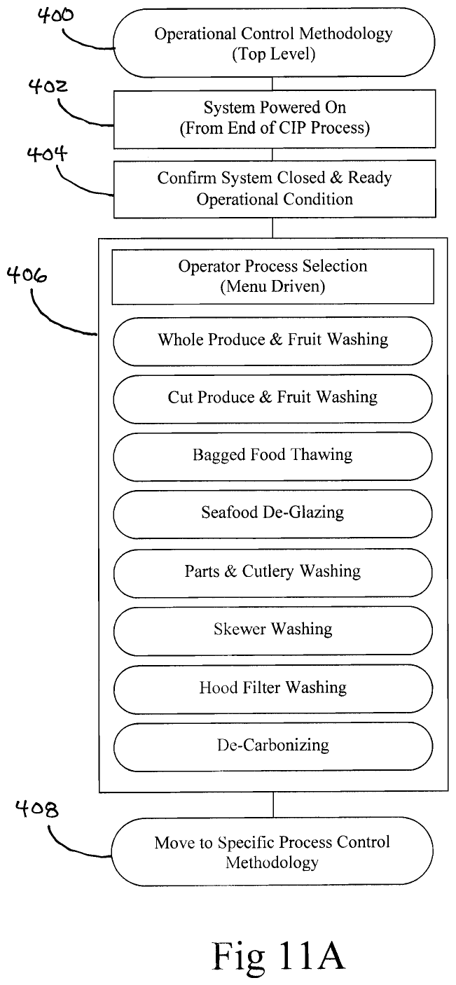

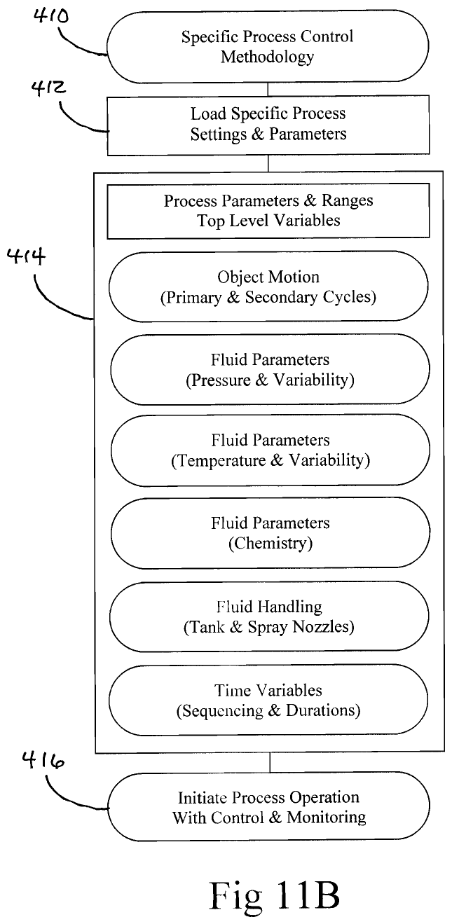

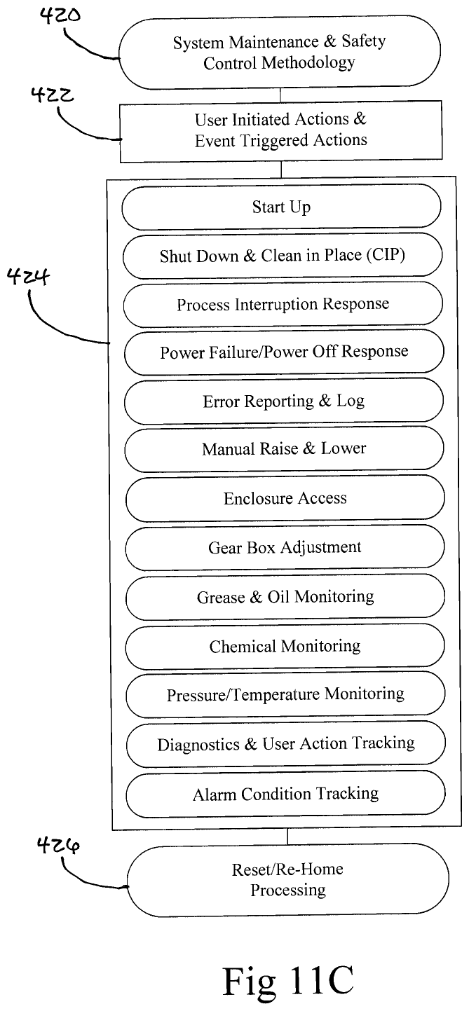

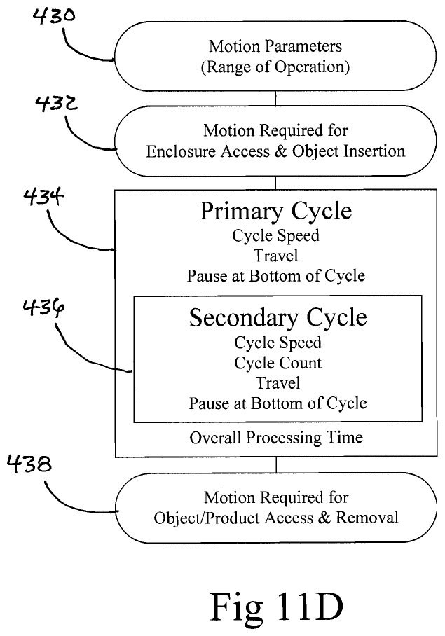

Reference is finally made to FIGS. 11A-11D for descriptions of the high-level methodology of the programmed control system of the present invention. The system is intended to be extremely versatile in its applicability to different objects and products to be handled. FIG. 11A is a flowchart diagram of the top-level operational control method steps associated with generalized operation of the system of the present invention. Control methodology 400 initiates with a system power on 402 which may occur on start-up or on completion of a OP process. A self-check 404 confirms that the system is closed and ready for operation. The menu driven operator process selection 406 provides a wide range of specific programmed processes including (without limitation): whole produce and fruit washing; cut produce and fruit washing; bagged food thawing; seafood de-glazing; parts and cutlery washing; skewer washing; hood filter washing; and de-carbonizing. Once the specific process is selected, the system moves to the appropriate process control programming 408.

FIG. 11B is a flowchart diagram of the typical specific process control method steps associated with operating the system of the present invention to carry out a specific functionality (object washing, thawing, de-glazing, etc.). The specific process method 410 is initiated by loading the process settings and parameters 412, including any custom elements deemed appropriate by the user. The process parameters and ranges (variables) include (without limitation): object motion (primary and secondary cycles); fluid parameters (pressure, temperature, chemistry, and the variability of each parameter); fluid handling (tank and spray nozzles); and time variables involving sequencing and durations. Once the settings and parameters are loaded the operational process itself is initiated 416 with control and monitoring functionality.

FIG. 11C is a flowchart diagram of the typical system maintenance and safety control method steps associated with operating the system of the present invention to monitor its condition and to carry out maintenance and safety functionality. The specific maintenance and safety control method 420 is initiated upon a user action or an event triggered action 422, including any custom elements deemed appropriate by the user. The maintenance and safety processes and actions 424 include (without limitation): start up; shut down and clean in place (CIP); process interruption response; power failure/power off response; error reporting and logging; manual raising and lowering of the lift system; providing and monitoring enclosure access; gear box adjustment; grease and oil monitoring; chemical monitoring; pressure and temperature monitoring; diagnostics and user action tracking; and alarm condition tracking. Once the maintenance and safety actions are completed the operational rest/re-home process is initiated 426 to return the system to a nominal state.

FIG. 11D is a flowchart diagram of the typical motion parameters and cycles associated with generalized operation of the system of the present invention to carry out a specific functionality (object washing, thawing, de-glazing, etc.). The functionality described in FIG. 11D is but one example of the kind of variable motion parameters that can be implemented with the systems and methods of the present invention. Motion parameters 430, in this example and in most cases, begins with the motion required for enclosure access and object/product insertion 432. The typical motion process may include a primary cycle 434 that includes variable parameters of cycle speed, travel distance, pauses at the bottom of the cycle, and finally overall processing time. Within primary cycle 434 may preferably included one or more secondary cycles 436 that also involve parameters of cycle speed, travel distance, pauses at the bottom of the cycle, and cycle count. The motion process is typically concluded with the motion required for object/product access and removal 438.

The control system of the present invention includes the ability to create customized cycles including mixed loading of objects/products into the baskets and to also permit cycle interruption with “on the fly” modifications of the operational processes depending on monitored events or conditions and/or simple user preferences and changes. Some products and processes lend themselves to mixed loading for efficiency while others do not. The system is programmed to recognize and even suggest such customized operation of one process for different products or, in some cases, multiple processes for a single product.

The system is additionally responsive to changes in conditions as detected by temperature, pressure, and chemical monitoring. That is, automatic alterations of standard processes may be implemented where, for example, a deglazing process eliminates ice more quickly than the volume of product might have indicated.

Although the present invention has been described in conjunction with a number of preferred embodiments, those skilled in the art will recognize modifications to these embodiments that still fall within the spirit and scope of the invention. Use of the system of the present invention may be carried out with a wide range of fluids, from tap water to specialized, non-toxic cleaning baths. Likewise, although the system has been described as finding particular use in washing fruits and vegetables, the operation of the system could benefit the washing or cleaning of a wide variety of objects used in the food preparation industry and elsewhere.

1. A chemical dispensing system comprising;
a chemical manifold including at least one chemical inlet valve;
such at least one chemical valve being operably connected to a chemical reservoir;
a vacuum source to create a vacuum within the manifold;
a diluent valve to provide a flow of diluent for transporting chemicals through the manifold at a first dilution rate;
such diluent flow being precisely metered.

2. The apparatus of claim 1 wherein the diluent valve and the at least one chemical inlet valve are operably connected to a control means.

3. The apparatus of claim 2 wherein the diluent valve and the at least one chemical inlet valve can be cycled on and off to by the control means to modulate the first dilution rate.

4. The apparatus of claim 1 where the vacuum source is an eductor or inductor.

5. The apparatus of claim 4 wherein the diluent and the chemical flow into the eductor inlet and become mixed with additional diluent to create a second dilution rate.

6. The apparatus of claim 1, where a substantially higher flow flush out valve is incorporated to flush out the manifold and chemical lines with diluent after dispensing has completed.

7. The apparatus of claim 6 wherein the flush out valve can be operated at multiple metered flow rates wherein it can perform the functions of both the diluent valve and the flush out valve.

8. The apparatus of claim 5 wherein the diluent and chemical flowing from the eductor, join a third flow of diluent creating a third dilution rate.

9. A chemical dispensing system comprising;
a chemical manifold including at least one chemical inlet valve;
such at least one chemical valve being operably connected to a chemical reservoir;
a vacuum source to create a vacuum within the manifold;
a vacuum sensor;
such system operably connected to a control means;
the control means opening the at least one chemical valve;
the control means taking a vacuum reading from the vacuum sensor;
the control means determining if the chemical is dispensing correctly based on a first vacuum range.

10. The apparatus of claim 9 wherein the control means determines if the operably connected chemical reservoir is empty based on a second vacuum range.

11. The apparatus of claim 9 wherein the control means determines if the at least one chemical inlet valve has malfunctioned based on the vacuum reading not being within either of the prescribed vacuum ranges.

12. The apparatus of claim 9 wherein the monitoring of the applicable vacuum ranges occurs singularly.

13. The apparatus of claim 9 wherein the monitoring of the applicable vacuum ranges occurs periodically.

14. The apparatus of claim 9 wherein the monitoring of the applicable vacuum ranges occurs continuously.

15. A system for introducing at least one mass of objects to and removing at least one mass of objects from a volume of fluid, the system comprising;
a structure for holding a volume of fluid;
a dedicated mechanical system for creating a substantially vertical linear motion for introducing the at least one mass of objects to and removing the at least one mass of objects from the volume of fluid;
a support structure associated with the dedicated mechanical system that extends below the mechanical system;
at least one permeable structure for holding the at least one mass of objects;
such at least one permeable structure associated with the support structure;
such dedicated mechanical system supported by a structure in proximity to the structure for holding the volume of fluid; and
the location of such dedicated mechanical system being at least partially above the fluid level present in the structure for holding the volume of fluid.

16. The system as in claim 15 where such dedicated mechanical system is supported by the same structure that supports the structure for holding the volume of fluid.

17. The system as in claim 15 where the at least one permeable structure remains partially submersed for a portion of time.

18. The system as in claim 15 where the at least one permeable structure remains fully submersed for a portion of time.

19. A method of washing, thawing or processing masses of objects such method including the steps of:
filling a structure for holding a volume of fluid with a fluid;
monitoring the temperature of such volume of fluid;
adding heating or cooling energy to the volume of fluid to achieve a predetermined temperature range based on the process of washing, thawing or processing being performed;
placing at least one mass of objects at least partially onto or within at least one permeable structure;
the at least one permeable structure being associated with a dedicated mechanical system that is at least partially above the fluid level present in the structure for holding the volume of fluid;
initiating a predetermined process to introduce the at least one mass of objects in the at least one permeable structure to the volume of fluid by means of the dedicated mechanical system;
continuing to monitor the fluid temperature and if required, adding heating or cooling energy to the fluid as needed to maintain the predetermined temperature range; and
upon the completion of the predetermined process, removing the at least one mass of objects from the at least one permeable structure.

20. The method as in claim 19 where the at least one mass of objects in the at least one permeable structure is introduced to the body of fluid to predetermined levels based on the washing, thawing or processing being performed.

21. A system for washing skewers, the system comprising;
a structure for holding a volume of fluid;
a dedicated mechanical system for creating a substantially vertical linear motion for introducing the at least one skewer into and removing the at least one skewer from the volume of fluid;
a support structure associated with the dedicated mechanical system that extends below the mechanical system;
at least one skewer rack structure for holding the at least one skewer;
such at least one skewer rack structure associated with the support structure;
such dedicated mechanical system supported by a structure in proximity to the structure for holding the volume of fluid; and
the location of such dedicated mechanical system being at least partially above the fluid level present in the structure for holding the volume of fluid.
